(19) United States
(12) Patent Application Publication
(10) Pub. No.: US 2011/0272893 A1
(43) Pub. Date: Nov. 10, 2011

(54) Labyrinth Seal For A Turbomachine

(75) Inventor: Tilmann RAIBLE, Oberhausen (DE)

(73) Assignee: MAN Diesel & Turbo SE, Augsburg (DE)

(21) Appl. No.: 13/103,357

(22) Filed: May 9, 2011

(30) Foreign Application Priority Data
May 7, 2010 (DE) 10 2010 028 732.6

(51) Int. Cl. F16J 15/447

(52) U.S. Cl. 277/419

(57) ABSTRACT

Labyrinth seal for a turbomachine having a plurality of elongated seal blades arranged along a longitudinal direction of the labyrinth seal next to one another and at a distance from one another so that a chamber is formed between adjacent seal blades. The seal blades each have a free end and at least one seal wall extending in longitudinal direction of the labyrinth seal. A seal gap is formed between each free end and the seal wall, adjacent chambers being in fluid communication with one another by the seal gap so that a working fluid impinging on the labyrinth seal can flow through the labyrinth seal in a throttled manner in a throttling direction proceeding from a first seal blade to a final seal blade. A fluid discharge device is provided that is arranged to bring about a continuous reduction in a specific enthalpy of the working fluid by discharging working fluid from the labyrinth seal along the throttling direction.

### BACKGROUND OF THE INVENTION

1. Field of the Invention

The invention is directed to a labyrinth seal having a plurality of elongated seal blades.

2. Description of the Related Art

A labyrinth seal of the type mentioned above is described, for example, in the introduction to the bachelor thesis of D. Strongilis on the subject of the “Carry-over Effect in See-through Labyrinth Seals”, submitted in January 2010 to the Department of Mechanical Engineering and Plant Management of the Technical University of Vienna.

FIG. 1 shows a labyrinth seal 1a, also known as a full labyrinth, is shown in Illustration 1.2 of the above-cited bachelor thesis. The labyrinth seal 1a has a first seal wall 10 associated with a stator of the turbomachine and a second seal wall 20 associated with a rotor of the turbomachine, each of these seal walls 10, 20 extending in a longitudinal direction LR of the labyrinth seal 1a.

A plurality of elongated fins or seal blades 11, 21 are provided at the first seal wall 10 and second seal wall 20 and are arranged in longitudinal direction LR of the labyrinth seal 1a parallel alongside one another and at a distance from one another in each instance so that a chamber 30 is formed in each instance between adjacent seal blades 11, 21.

The seal blades 11, 21 each have a free end 12, 22, a seal gap S being formed between each free end 12, 22 of the seal blades 11, 21 and the respective opposite seal wall 10 and 20, respectively. Adjacent chambers 30 of the chambers 30 formed between the seal blades 11, 21 are in fluid communication with one another by the seal gap S so that a working fluid of the turbomachine impinging on the labyrinth seal 1a can flow through the labyrinth seal 1a in a throttled manner in a throttling direction DR corresponding to the flow direction shown in FIG. 1 from a first seal blade (the seal blade 11 at far left in FIG. 1) to a final seal blade (the seal blade 11 at far right in FIG. 1).

Turbomachinery such as back-pressure turbines and condensing turbines having high input parameters (e.g., high pressure) in a high-pressure stage require shaped labyrinth seal systems for sealing.

Supercritical labyrinth seals (with a supersonic outflow at a final seal blade or final seal tip with respect to the throttling direction of the labyrinth seal) installed in turbomachinery have a load curve in which the load on the final seal blade is substantially greater than that on the preceding seal blades by reason of the supercritical pressure ratio existing at the former. Further, a large quantity of seal blades is needed to reduce a high total pressure ratio.

The throttling of pressure by a labyrinth seal is usually described by a Fanno curve. This curve is characterized by a relatively flat line at the start of the labyrinth seal, the final throttling point (final seal blade), as was mentioned, always having the highest load, which is caused by the specific enthalpy of the expanded gas (working fluid flowing through the labyrinth seal), where the specific enthalpy is assumed to be constant.

FIG. 1 shows the schematic line of an expansion corresponding to a Fanno curve F1 with a supercritical pressure ratio at the final stage (or shortly after the final seal blade 11) of the labyrinth seal 1a, where pᵢ is an input pressure of the working fluid, p_{final} is a pressure of the working fluid at the final stage of the labyrinth seal 1a, and pₐ is a pressure of the working fluid after the final stage of the labyrinth seal 1a or an output pressure of the working fluid.

The above-cited bachelor thesis by D. Strongilis, e.g., Sections 2.3 and 2.4, are referred to respecting details about the formation of a supercritical pressure ratio at the final stage of a labyrinth seal.

To divide a high total pressure ratio into easily reducible stages, so called intermediate suction locations are used in the prior art as described, e.g., in DE 26 35 918 B1. However, in order for intermediate suction locations to function reliably, the respective pressure level must be maintained in a correspondingly reliable manner resulting in corresponding expenditure on controls and monitoring. Moreover, turbomachines with intermediate suction are structurally longer.

### SUMMARY OF THE INVENTION

It is an object of one embodiment of the invention to provide a labyrinth seal for a turbomachine that makes do with a smaller quantity of seal blades and seal tips compared to the prior art with the same total pressure ratio and with uniformly loaded seal blades and seal tips.

According to one embodiment of the invention, a labyrinth seal for a turbomachine has a plurality of elongated seal blades arranged along a longitudinal direction of the labyrinth seal alongside one another and at a distance from one another in each instance so that a chamber is formed in each instance between adjacent seal blades, the seal blades each having a free end and at least one seal wall extending in longitudinal direction of the labyrinth seal, a seal gap being formed between each free end of the seal blades and the at least one seal wall, and adjacent chambers of the chambers formed between the seal blades being in fluid communication with one another by the seal gap so that a working fluid of the turbomachine impinging on the labyrinth seal can flow through the labyrinth seal in a throttled manner in a throttling direction proceeding from a first seal blade to a final seal blade. The labyrinth seal according to one embodiment of the invention is characterized in that a fluid discharge device is provided which is arranged so as to bring about a continuous reduction in a specific enthalpy of the working fluid by discharging working fluid from the labyrinth seal along the throttling direction.

By continuously reducing the specific enthalpy of the working fluid along the throttling direction, a steeper throttling curve (Fanno curve) and, therefore, a smaller quantity of, and uniform loading of, seal blades can be achieved compared to the prior art with the same total pressure ratio.

The seal concept according to the invention is suitable, e.g., for turbomachines that are not optimized for the highest possible efficiency and which therefore also stay competitive with an increased mass flow loss through the labyrinth seal. The omission of intermediate suction locations and associated systems and the shorter construction of the labyrinth seal provide considerable advantages in terms of cost and, therefore, competitiveness in every case.

According to one embodiment of the invention, the fluid discharge device is arranged to discharge the working fluid from at least some of the chambers in order to bring about the continuous reduction in the specific enthalpy of the working fluid.

By discharging working fluid from some of the chambers or from all of the chambers, the desired continuous reduction in specific enthalpy of the working fluid can be brought about in a simple and reliable manner.

Therefore, the slope (steepness) of the throttling curve (Fanno curve) to be achieved can be influenced depending on the thermodynamic factors specific to the seal. The fluid discharge device is preferably arranged so as, e.g., to discharge the working fluid from every second chamber along the throttling direction in order to bring about the continuous reduction of the specific enthalpy of the working fluid.

According to one embodiment of the invention, the fluid discharge device is arranged to discharge a plurality of specific, i.e., separately adjustable, mass flows of working fluid along the throttling direction in order to bring about the continuous reduction in the specific enthalpy of the working fluid.

In this way, the reduction of the specific enthalpy of the working fluid can be better controlled or regulated, as the case may be.

According to one embodiment of the invention, the fluid discharge device is arranged to discharge at least partially different mass flows of working fluid as specific mass flows in order to bring about the continuous reduction in the specific enthalpy of the working fluid.

Depending on the thermodynamic factors specific to the seal, it may be necessary, for example, to discharge more working fluid in a certain longitudinal portion of the labyrinth seal and to discharge less working fluid in another determined longitudinal portion of the labyrinth seal in order to achieve a determined desired or ideal line of the throttling curve (Fanno curve). This is realized by the possibility provided by the invention of discharging at least partially different mass flows of working fluid.

According to one embodiment of the invention, the fluid discharge device is arranged to discharge the working fluid from the labyrinth seal against an ambient pressure, i.e., against atmospheric pressure.

In this way, cost-intensive pressure control can be dispensed with. While this causes a somewhat larger mass flow loss through the labyrinth seal, it offers a considerable cost advantage by dispensing with cost-intensive pressure control and therefore provides a competitive advantage.

According to one embodiment of the invention, the labyrinth seal has an intermediate discharge device arranged so as to discharge working fluid from the labyrinth seal between the first seal blade and the final seal blade against a predetermined pressure, which is higher than an ambient pressure. The fluid discharge device has a first fluid discharge unit arranged to discharge the working fluid from the labyrinth seal in a first longitudinal portion of the labyrinth seal against the predetermined pressure which is increased relative to the ambient pressure in order to bring about a first continuous reduction of the specific enthalpy of the working fluid and has a second fluid discharge unit arranged to discharge the working fluid from the labyrinth seal in a second longitudinal portion of the labyrinth seal against the ambient pressure in order to bring about a second continuous reduction of the specific enthalpy of the working fluid.

This embodiment of the invention is especially suited to high performance turbomachines because there is a lower mass flow loss through the labyrinth seal in this case in that the continuous discharge of working fluid for the continuous reduction of the specific enthalpy of the working fluid is carried out against the pressure, which is increased over the ambient pressure and is preferably at a reduced medium pressure level relative to an input pressure in the labyrinth seal.

The first fluid discharge unit is preferably arranged upstream of the intermediate discharge device along the throttling direction. Further, the first fluid discharge unit is preferably arranged upstream of the second fluid discharge unit along the throttling direction. Further, the intermediate discharge device is preferably arranged so as to discharge the working fluid from the labyrinth seal between the first fluid discharge unit and the second fluid discharge unit.

Therefore, the continuous discharge of working fluid for the continuous reduction of the specific enthalpy of the working fluid can ideally work gradually against a medium pressure level (first fluid discharge unit) and optionally against the ambient pressure (second fluid discharge unit) so that the advantage of a lower mass flow loss through the labyrinth seal is achieved on the one hand and the advantage of a smaller quantity of seal blades which are uniformly loaded is also achieved on the other hand.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will be described in more detail in the following with reference to preferred embodiment forms and the accompanying drawings.

FIG. 1 is a Fanno curve of a labyrinth seal according to the prior art with critical final seal stage;

FIG. 2 is a Fanno curve of a labyrinth seal according to an embodiment form of the invention; and

FIG. 3 is a Fanno curve of a labyrinth seal according to another embodiment form of the invention.

### DETAILED DESCRIPTION OF THE PRESENTLY PREFERRED EMBODIMENTS

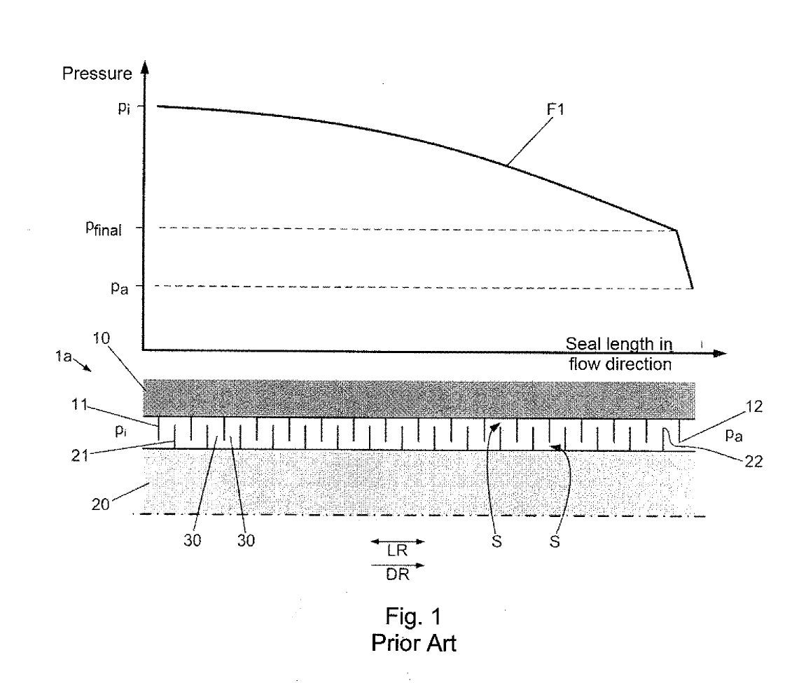

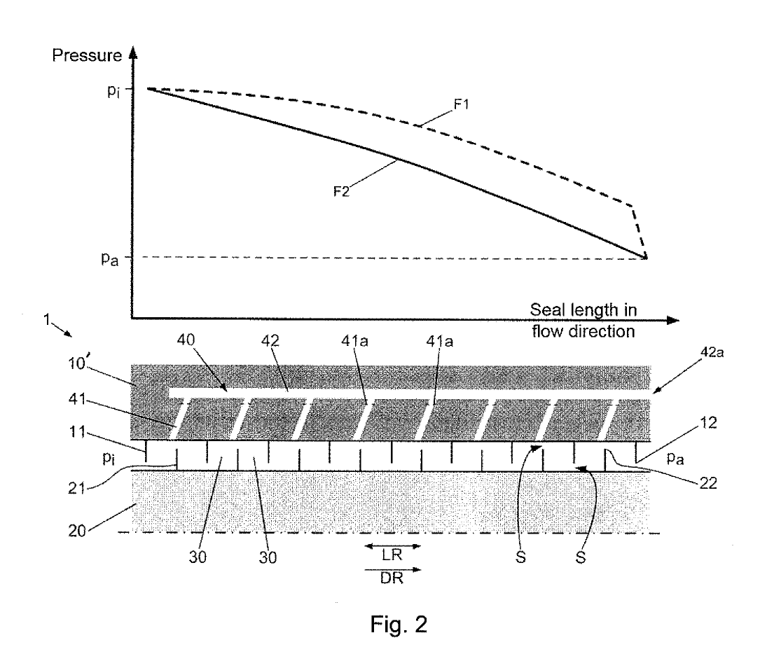

The upper area of FIG. 2 shows a Fanno curve F2 of a labyrinth seal 1, shown at bottom in FIG. 2, of a turbomachine (not shown in its entirety) according to one embodiment of the invention. For purposes of comparison, FIG. 2 also shows the Fanno curve F1 from FIG. 1 in dashes in the upper area.

In FIG. 2, as in FIG. 1, pᵢ designates the input pressure of the working fluid in the labyrinth seal 1 and pₐ designates the pressure of the working fluid after the final stage of the labyrinth seal 1, or the output pressure of the working fluid.

As can be seen from FIG. 2, the Fanno curve F2 associated with the labyrinth seal 1 according to one embodiment of the invention has a steeper and also more uniform curve than the Fanno curve F1 shown in dashes which is associated with the prior-art labyrinth seal 1a with no jumps in pressure or graduation in pressure at the final stage of the labyrinth seal 1 according to the invention.

The labyrinth seal 1 according to the invention has a first seal wall 10′ associated with a stator of the turbomachine and a second seal wall 20 associated with a rotor of the turbomachine, each seal wall 10′, 20 extending in a longitudinal direction LR of the labyrinth seal 1.

A plurality of elongated seal blades 11, 21 are provided at the first seal wall 10′ and second seal wall 20 and are arranged in parallel alongside one another and at a distance from one another, respectively, in the longitudinal direction LR of the labyrinth seal 1 so that a chamber 30 is formed in each instance between adjacent seal blades 11, 21.

The seal blades 11, 21 each have a free end 12, 22. A seal gap S is formed between each free end 12, 22 of the seal blades 11, 21 and the respective opposite seal wall 10′ and 20, respectively. Adjacent chambers 30 of the chambers 30 formed between the seal blades 11, 21 are in fluid communication with one another by the seal gap S so that a working fluid of the turbomachine impinging on the labyrinth seal 1 can flow through the labyrinth seal 1 in a throttled manner in a throttling direction DR corresponding to the flow direction shown in FIG. 2 proceeding from a first seal blade (the seal blade 11 at far left in FIG. 2) to a final seal blade (the seal blade 11 at far right in FIG. 2).

By seal wall is meant within the meaning of one embodiment of the invention a wall forming a seal gap S with a free end 12, 22 of the seal blades 11, 21. Accordingly, the labyrinth seal 1 shown in the drawing has two seal walls 10′, 20. On the other hand, according to an embodiment form of the invention which is not shown, a labyrinth seal constructed as a see-through labyrinth as in Illustration 1.1 of the above-cited bachelor thesis could also have only one individual seal wall (associated, e.g., with the stator of the turbomachine), and the seal blades could extend from a base wall (associated, e.g., with the rotor of the turbomachine).

Accordingly, in the embodiment form of the labyrinth seal 1 shown in FIG. 2, each of the two seal walls 10′, 20 simultaneously forms a base wall from which the seal blades 11 and 21 extend.

Further, the labyrinth seal 1 according to the invention has a fluid discharge device 40 arranged to bring about a continuous reduction of a specific enthalpy h of the working fluid by discharging working fluid from the labyrinth seal 1 along the throttling direction DR.

Enthalpy H describes the energy of a thermodynamic system. Enthalpy H is defined as the sum of the internal energy U plus the pressure-volume work pV:

H=U+pV (1)

Internal energy U is made up of thermal energy based on the undirected motion of molecules (kinetic energy, rotational energy, vibratory energy), the chemical bonding energy, and the potential energy of the atomic nuclei.

Specific enthalpy h describes enthalpy H in relation to mass and is defined as a unit by kJ/kg.

For purposes of the continuous reduction of the specific enthalpy h of the working fluid, the fluid discharge device 40 has a plurality of extraction passages 41 in the first seal wall 10′. In this instance, the extraction passages 41 are formed as bore holes and are in fluid communication at one end respectively with one of the chambers 30 of the labyrinth seal 1 and open out at the other end into a common discharge passage 42 that has a passage outlet 42a which opens into the environment, i.e., that works against ambient pressure (atmospheric pressure).

In other words, the continuous reduction of the specific enthalpy h is achieved by a “continuous” tapping of the individual seal stages by bore holes 41.

Therefore, by the above-described construction of the fluid discharge device 40, this fluid discharge device 40 is arranged so as to discharge the working fluid from the labyrinth seal 1 against ambient pressure.

A suction location (not shown) that blows off freely into the environment is connected to the passage outlet 42a so that the working fluid can be drawn out of the labyrinth seal 1 via the extraction passages 41 and the discharge passage 42.

As can be seen from FIG. 2, the fluid discharge device 40 is arranged to discharge the working fluid from at least some of the chambers 30 to bring about the continuous reduction of the specific enthalpy h of the working fluid. According to the present embodiment form of the labyrinth seal 1 according to the invention, the fluid discharge device 40 is arranged so as to discharge the working fluid from every second chamber 30 along the throttling direction DR to cause the continuous reduction of the specific enthalpy h of the working fluid. In other words, one of the extraction passages 41 branches off from every second chamber 30 into the discharge passage 42.

Within the meaning of the invention, the extraction passages 41 can branch off from any location of the chambers 30, e.g., the first, fourth, sixth chamber 30, or in any other combination.

A diaphragm 41a is inserted, preferably screwed into the end of each extraction passage 41 so that the flow of fluid through the extraction passages 41 can be adapted individually by the selection of corresponding diaphragm diameters. For example, all of the diaphragms 41a can have the same diameter, groups of diaphragms 41a within a group having identical diaphragm diameters can have different diameters, or, e.g., all of the diaphragms 41a can have different diameters.

Accordingly, the fluid discharge device 40 is arranged so as to discharge a plurality of specific mass flows of working fluid, and particularly at least partially different mass flows of working fluid, along the throttling direction DR in order to bring about the continuous reduction of the specific enthalpy h of the working fluid.

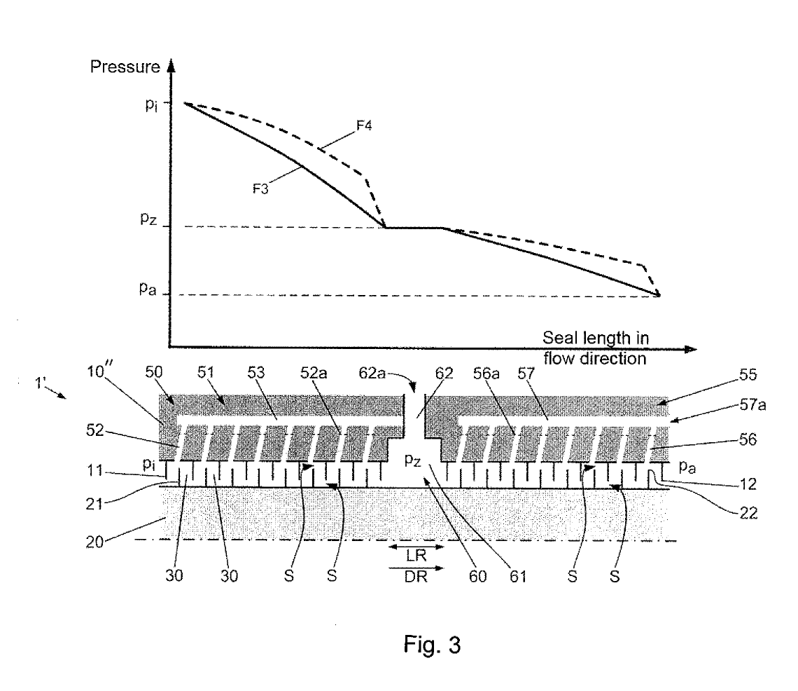

Shown in the upper area of FIG. 3 is a Fanno curve F3 of a labyrinth seal 1′, shown in the lower area, of a turbomachine (not shown in its entirety) according to another embodiment form of the invention. Further, for purposes of comparison, a Fanno curve F4 which is associated with a labyrinth seal, not shown, with intermediate suction according to the prior art is shown in dashed lines in the upper area of FIG. 2.

Apart from some differences, the labyrinth seal 1′ according to FIG. 3 is identical to the labyrinth seal 1 shown in FIG. 2. Therefore, only these differences will be described in the following, wherein identical reference numerals designate components identical or similar to those of the labyrinth seal 1 according to FIG. 2.

The labyrinth seal 1′ has an intermediate discharge device 60 and a fluid discharge device 50 with a first fluid discharge unit 51 and a second fluid discharge unit 55.

The first fluid discharge unit 51 is arranged upstream of the second fluid discharge unit 55 along the throttling direction DR; the first fluid discharge unit 51 is arranged upstream of the intermediate discharge device 60 along the throttling direction DR.

The intermediate discharge device 60 is arranged approximately midway between the two fluid discharge units 51, 55 with respect to a length of the labyrinth seal 1′ and has an intermediate discharge chamber 61 formed in an area without seal blades and an intermediate discharge passage 62 whose one end is in fluid communication with the intermediate discharge chamber 61 and which has at its other end an intermediate passage outlet 62a which is connected to a pressure-controlled suction device (not shown).

Accordingly, the intermediate discharge device 60 is arranged to discharge the working fluid from the labyrinth seal 1′ between the first fluid discharge unit 51 and the second fluid discharge unit 55.

More precisely, the intermediate discharge device 60 is arranged to discharge working fluid from the labyrinth seal 1′ between the first seal blade (the seal blade 11 at far left in FIG. 3) and the final seal blade (the seal blade 11 at far right in FIG. 3) against a predetermined pressure that is higher than the ambient pressure.

This increased pressure is provided by the pressure-controlled suction device and is an intermediate pressure pᵢ at a medium pressure level that is reduced relative to the input pressure pₐ of the labyrinth seal 1′.

The first fluid discharge unit 51 of the fluid discharge device 50 is arranged to discharge the working fluid from the labyrinth seal 1′ in a first longitudinal portion of the labyrinth seal 1′, located to the left of the intermediate discharge chamber 61 of the intermediate discharge device 60 in FIG. 3, against the predetermined pressure (intermediate pressure p_{z}) which is increased over the ambient pressure in order to bring about a first continuous reduction of the specific enthalpy h of the working fluid.

For this purpose, the first fluid discharge unit 51 has in the first seal wall 10″ a plurality of first extraction passages 52 constructed in this instance as bore holes and whose one end is in fluid communication respectively with one of the chambers 30 of the labyrinth seal 1′ located to the left of the intermediate discharge chamber 61 of the intermediate discharge device 60 and, at the other end, open into a common first discharge passage 53 which opens in turn into the intermediate discharge passage 62.

The second fluid discharge unit 55 of the fluid discharge device 50 is arranged so as to discharge the working fluid from the labyrinth seal 1′ in a second longitudinal portion of the labyrinth seal 1′, located to the right of the intermediate discharge chamber 61 of the intermediate discharge device 60 in FIG. 3, against the ambient pressure in order to bring about a second continuous reduction of the specific enthalpy h of the working fluid.

For this purpose, the second fluid discharge unit 55 has in the first seal wall 10″ a plurality of second extraction passages 56 which are constructed in this instance as bore holes and whose one end is in fluid communication respectively with one of the chambers 30 of the labyrinth seal 1′ located to the right of the intermediate discharge chamber 61 of the intermediate discharge device 60 and, at the other end, open into a common second discharge passage 57 which in turn has a passage outlet 57a opening into the environment, i.e., working against ambient pressure.

A suction location (not shown), which blows off freely into the environment, is connected to the passage outlet 57a so that the working fluid can be sucked out of the labyrinth seal 1 via the second extraction passages 56 and the discharge passage 57.

As can be seen from FIG. 3, each fluid discharge unit 51, 55 of the fluid discharge device 50 is arranged so as to discharge the working fluid from at least some of the chambers 30 in order to bring about the continuous reduction of the specific enthalpy h of the working fluid. According to the present embodiment form of the labyrinth seal 1′ according to the invention, each fluid discharge unit 51, 55 of the fluid discharge device 50 is arranged so as to discharge the working fluid from every second chamber 30 along the throttling direction DR in order to cause the respective continuous reduction of the specific enthalpy h of the working fluid. In other words, one of the first extraction passages 52 and second extraction passages 56 branches off from every second chamber 30 into the first discharge passage 53 and second discharge passage 57, respectively.

A diaphragm 52a and 56a, respectively, is inserted, preferably screwed into the end of each of the first extraction passage 52 and second extraction passages 56 so that the flow of fluid through the extraction passages 52, 56 can be adapted individually by selection of corresponding diaphragm diameters. For example, all of the diaphragms 52a, 56a can have the same diameter, groups of diaphragms 52a, 56a within a group having identical diaphragm diameters can have different diameters, or, e.g., all of the diaphragms 52a, 56a can have different diameters.

Accordingly, each fluid discharge unit 51, 55 of the fluid discharge device 50 is arranged so as to discharge a plurality of specific mass flows of working fluid, and particularly at least partially different mass flows of working fluid, along the throttling direction DR in order to bring about the respective continuous reduction of the specific enthalpy h of the working fluid.

As can be seen from FIG. 3, the Fanno curve F3 associated with the labyrinth seal 1′ according to the invention has a steeper and also more uniform curve than the Fanno curve F4, shown in dashes, which is associated with the prior-art labyrinth seal in the respective length portions with no jumps in pressure or graduation in pressure at the respective final stage of a longitudinal portion of the labyrinth seal 1 according to the invention.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

I claim:

1. A labyrinth seal for a turbomachine comprising:
a first plurality of elongated seal blades arranged alongside one another at a distance from one another along a first seal wall in a longitudinal direction of the labyrinth seal, each of the first plural elongated seal blades having a first free end;
a second plurality of elongated seal blades arranged alongside one another at a distance from one another along a second seal wall, the second seal wall facing the first seal wall in a longitudinal direction of the labyrinth seal so that a respective chamber is formed in each instance between adjacent ones of the first and second seal blades, each of the second plural elongated seal blades having a second free end;
a respective seal gap is formed between each respective free end of the first and second plural seal blades and the one of the first and second seal wall that the respective free end faces, adjacent chambers being in fluid communication with one another by the seal gap so that a working fluid of the turbomachine impinging on the labyrinth seal can flow through the labyrinth seal in a throttled manner in a throttling direction proceeding from a first seal blade to a final seal blade; and
a fluid discharge device configured to provide a continuous reduction in a specific enthalpy of the working fluid by discharging working fluid from the labyrinth seal along the throttling direction.

2. The labyrinth seal according to claim 1, wherein the fluid discharge device is configured to discharge the working fluid from at least some of the chambers to bring about the continuous reduction in the specific enthalpy of the working fluid.

3. The labyrinth seal according to claim 2, wherein the fluid discharge device is configured to discharge the working fluid from every second chamber along the throttling direction to bring about the continuous reduction in the specific enthalpy of the working fluid.

4. The labyrinth seal according to claim 1, wherein the fluid discharge device is configured to discharge a plurality of specific mass flows of working fluid along the throttling direction to bring about the continuous reduction in the specific enthalpy of the working fluid.

5. The labyrinth seal according to claim 4, wherein the fluid discharge device is configured to discharge at least partially different mass flows of working fluid as specific mass flows to bring about the continuous reduction in the specific enthalpy of the working fluid.

6. The labyrinth seal according to claim 1, wherein the fluid discharge device is configured to discharge the working fluid from the labyrinth seal against an ambient pressure.

7. The labyrinth seal according to claim 1, further comprising:
an intermediate discharge device configured to discharge working fluid from the labyrinth seal at a location in the first seal wall between the first seal blade and the final seal blade against a predetermined pressure that is higher than an ambient pressure,
wherein the fluid discharge device comprises:
a first fluid discharge unit configured to discharge the working fluid from the labyrinth seal in a first longitudinal portion of the labyrinth seal against the predetermined pressure to bring about a first continuous reduction of the specific enthalpy of the working fluid; and
a second fluid discharge unit configured to discharge the working fluid from the labyrinth seal against the ambient pressure in a second longitudinal portion of the labyrinth seal to bring about a second continuous reduction of the specific enthalpy of the working fluid.

8. The labyrinth seal according to claim 7, wherein the first fluid discharge unit is arranged upstream of the intermediate discharge device along the throttling direction.

9. The labyrinth seal according to claim 8, wherein the first fluid discharge unit is arranged upstream of the second fluid discharge unit along the throttling direction.

10. The labyrinth seal according to claim 7, wherein the intermediate discharge device is configured to discharge the working fluid from the labyrinth seal between the first fluid discharge unit and the second fluid discharge unit.

11. The labyrinth seal according to claim 1, wherein the fluid discharge device further comprises:
a plurality of passages each of the plural passages coupled at a first end to a respective seal gap; and
a discharge passage coupled to a second end of each of the plural passages, the discharge passage having a passage outlet.

12. A labyrinth seal for a turbomachine comprising:
a first plurality of elongated seal blades arranged alongside one another at a distance from one another along a first seal wall in a longitudinal direction of the labyrinth seal, each of the first plural elongated seal blades having a first free end;
a second plurality of elongated seal blades arranged alongside one another at a distance from one another along a second seal wall, the second seal wall facing the first seal wall in a longitudinal direction of the labyrinth seal so that a respective chamber is formed in each instance between adjacent ones of the first and second seal blades, each of the second plural elongated seal blades having a second free end;
a respective seal gap is formed between each respective free end of the first and second plural seal blades and the one of the first and second seal wall that the respective free end faces, adjacent chambers being in fluid communication with one another by the seal gap so that a working fluid of the turbomachine impinging on the labyrinth seal can flow through the labyrinth seal in a throttled manner in a throttling direction proceeding from a first seal blade to a final seal blade; and
a fluid discharge device comprising:
a plurality of passages each of the plural passages coupled at a first end to one of a respective chamber and a respective seal gap; and
a discharge passage coupled to a second end of each of the plural passages, the discharge passage having a passage outlet.
